(19) United States
(12) Patent Application Publication
(10) Pub. No.: US 2011/0099098 A1
(43) Pub. Date: Apr. 28, 2011

(54) SYSTEM FOR MANAGING AND REPORTING FINANCIAL ACCOUNT ACTIVITY

(75) Inventor: William Schaich, Jefferson Hills, PA (US)

(73) Assignee: Deluxe Corporation, Shoreview, MN (US)

(21) Appl. No.: 12/868,528

(22) Filed: Aug. 25, 2010

Related U.S. Application Data
(63) Continuation of application No. 10/778,674, filed on Feb. 13, 2004, now abandoned.
(60) Provisional application No. 60/448,075, filed on Feb. 14, 2003.

(51) Int. Cl. G06Q 40/00

(52) U.S. Cl. 705/35

(57) ABSTRACT

A system for managing and reporting financial account activity to detect unauthorized access and prevent fraudulent transactions. The system processes checking and credit activities for a plurality of subscribers and provides notifications to subscribers based on the predetermined conditions and preferred communication options established by the subscribers.

### PRIORITY OF INVENTION

This application is a Continuation of U.S. application Ser. No. 10/778,647, filed Feb. 13, 2004, which claims priority to U.S. Provisional Application No. 60/448,075, filed Feb. 14, 2003, which applications are incorporated herein by reference in their entirety.

### FIELD OF THE INVENTION

The present system relates generally to financial account reporting and management and in particular to a system for reporting and managing financial account activity including, but not limited to, checking and credit account transactions.

### BACKGROUND

Credit card and check fraud costs cardholders and businesses hundreds of millions of dollars each year. Fraud can occur in different ways. For example, check fraud is committed by obtaining a person's checks and drafting checks against the account. The checks can be wrongfully ordered by a fraudulent check order that impersonates the account holder. Another example is that a fraud may use another's credit card number without their knowledge.

One way consumers are alerted to fraudulent activity with their credit cards or checking accounts is to receive a statement with the fraudulent transactions via the mail after the fraudulent transaction has occurred. Significant fraud can occur before the statement is received.

Thus, there is a need in the art for a system for monitoring financial transaction activity to detect or prevent fraud.

### SUMMARY

The present system relates generally to methods for managing and reporting financial account activity to detect unauthorized access and prevent fraudulent transactions.

The present subject matter provides a system that monitors and receives paper check order information, stores user notification preferences and sends notifications based on the notification preferences and the paper check order information. The user notification preferences include new check orders or new check orders to a new address.

The present system includes a means for receiving checking account information and monitoring changes and modifications based on predetermined user notification preferences such as an insufficient funds notification.

The present system provides a method for processing checking and credit activities for a plurality of users, including receiving paper check order information, receiving checking account information, receiving credit account information and providing notifications based on predetermined conditions and preferred communications options of the plurality of users using at least one of the check order information, checking account information, and credit account information. Such predetermined conditions may also include conditions predetermined by the service provider.

The present subject matter provides a system that sends out a communication requesting subscriber to verify receipt of check order confirms receipt of the check order.

Different notification and confirmation means are described including electronic mail transmissions to users, wireless communication, telephone, U.S. mail, fax, or other electronic communication devices.

This summary is an overview of some of the teachings of the present application and not intended to be an exclusive or exhaustive treatment of the present subject matter. Further details about the present subject matter are found in the detailed description and appended claims. Other aspects of the invention will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIG. 1 is a block diagram illustrating a system for reporting check order activity according to one embodiment of the present invention.

FIG. 2 is a block diagram of a messaging facility according to one embodiment of the present system.

FIG. 3 is a block diagram illustrating one embodiment for reporting check order and checking account activity.

FIG. 4 is a block diagram illustrating one embodiment for reporting check order, credit and checking account activity.

FIG. 5 is a flow chart showing how check and credit activity information are processed according to one embodiment of the present invention.

FIG. 6 is a flow chart showing how confirmation of new check orders are processed according to one embodiment of the present invention.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description provides examples, and the scope of the present invention is defined by the appended claims and their equivalents.

It should be noted that references to “an”, “one”, or “various” embodiments in this disclosure are not necessarily to the same embodiment, and such references contemplate more than one embodiment.

The present disclosure discusses a programmable and flexible system for monitoring and managing one or more financial account features. A customer of a financial institution can become a subscriber of the present system and provide notification instructions to the system to receive notice when certain events occur with their credit accounts, or with accounts having their personal information associated with them. This provides a subscriber increased protection against fraudulent activities by having rapid notification of predetermined events concerning their financial accounts. Such predetermined conditions may also include conditions predetermined by the service provider. The present system will be discussed in the context of communications with different financial institutions and different financial accounts. It is understood that the types of accounts, financial institutions, communications, and notification options may vary without departing from the scope of the present teachings. The examples provided herein are not intended in a limiting, exhaustive, or exclusive sense.

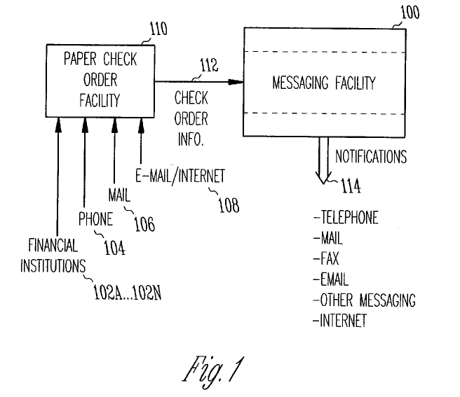

FIG. 1 is a block diagram illustrating a system for reporting check order activity according to one embodiment of the present invention. Messaging facility 100 receives check order information 112 from paper check order facility 110 and provides notifications 114 using a plurality of programmable notification options. Such options include, but are not limited to, telephone, mail, fax, e-mail, and electronic messaging, for example INTERNET communications. In one embodiment, cellular or other wireless communications are employed. Network communications are also available to provide notifications to various clients attached to a network. In varying embodiments and combinations, the notification options may be programmably selected so that different options are used for different types of communications and differing urgencies of communications. Other types and combinations of notifications may be employed without departing from the scope of the present system.

In one embodiment, paper check order facility 110 is a check printer. The check order information 112 is stored in a computer or other database and the information is downloaded to the messaging facility 100. In one embodiment, the paper check information 112 is downloaded upon activity of an identified subscriber account. In one embodiment, the paper check information 112 is downloaded in a batch mode. In one embodiment, the paper check information is 112 downloaded periodically. In one embodiment, the paper check information 112 is queried from a database. In one embodiment, the paper check information 112 is available via secure connection from one or more remote servers. Such downloads can be transmitted via a variety of different communication means including, but not limited to, a network connection, telephone connection, and/or wireless connection. In varying embodiments, the paper check information is stored in various locations and may be stored at a plurality of locations including, but not limited to, the messaging facility 100. It is understood that the check order info 112 may reside at a plurality of paper check printing facilities, common or disparate databases, or at databases of one or more financial institutions.

In FIG. 1, the paper check order facility 110 is any agency or service that takes printed check orders. Customers may enter check orders by different means, such as orders from financial institutions 102A-102N where they have checking accounts, telephone orders 104, mail orders 106, and electronic mail orders 108. Some paper check printers and financial institutions have web sites or other INTERNET communication means to provide secure paper check order facilities. One means includes a password and user identification for check re-orders and access to financial accounts. Other security means and other check order means may be employed without departing from the present system.

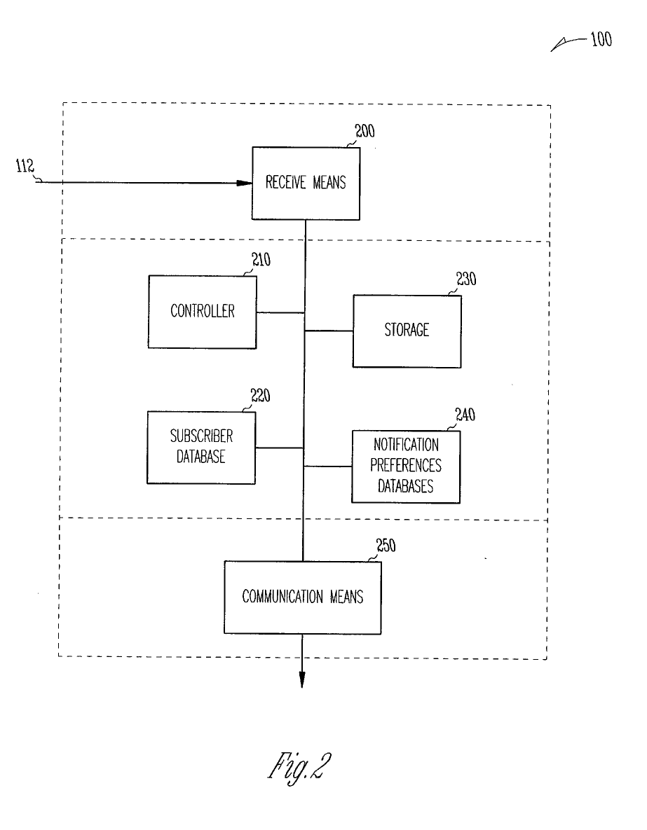

FIG. 2 shows one example of a messaging facility 100 according to one embodiment of the present invention. In one embodiment, the messaging facility 100 includes a controller 210 connected to receive means 200, storage 230, subscriber database 220, notification means 240, and communication means 250. In one embodiment, the controller 210 is a microprocessor performing steps to receive information from various information sources, such as check order information 112. In one embodiment, controller 210 is executing software in a computer system. In one embodiment, controller 210 is a combination of hardware and software. In one embodiment messaging facility 100 includes necessary firewalls, virus protection, data redundancy and recovery mechanisms.

In one embodiment, the messaging facility includes computers and personnel to manage the system and provide instructions to the system as requested by subscribers. In one embodiment, the messaging facility is executed on a computer system using software designed to accept subscriber information, notification instructions, account activity information, and provide notifications using the information to the subscribers. In one embodiment, the messaging facility 100 is a server based system capable of operating on the INTERNET with secure communication interfaces using encryption or other security measures to ensure that only authorized persons are able to access the system and receive notifications. In varying embodiments, the various portions of the messaging facility 100 reside at one or more physical locations. In one embodiment the various portions of the messaging facility 100 are virtually implemented within a computing network used for other confidential financial functions. In one embodiment, the messaging facility 100 is used to intercommunicate between different financial institutions. In one embodiment, the messaging facility 100 is used within an integrated financial institution. The various embodiments contained herein are provided to demonstrate the flexibility of the system and are not intended in an exclusive or limiting sense.

In one embodiment, check order activity information is downloaded from the paper check order facility 110 using information in subscriber database 220. Storage 230 is used to store the downloaded information for further processing as set forth below. In one embodiment, the received information includes check printing activity for each subscriber for a given time period. Notification preferences are stored in notification preferences database 240. The notifications are transmitted to the subscribers via communication means 250 and based on programmable settings stored in the notification preferences database 240. For example, assume that subscriber database 220 has entries for John Smith and Mary Jones. John Smith may have instructed the service provider operating the messaging means to send e-mail notifications to him over his cell phone if new checks are ordered in his name. As another example, Mary Jones will provide an instruction to receive an e-mail at her e-mail account if her check order includes numbers that are not in sequence, such as a new check order number that is out of sequence or gapped from her last printed check. Such instructions are stored in the preferences database, for example:

| Sub- | | Notification | Notify | Notify |
|---|---|---|---|---|
| scriber | ID No | Method | Address | Condition |
| John | 479-32-6789 | cellular | 612 333-4432 | new check |
| Smith | | telephone | | orders |
| Mary | 463-67-8790 | e-mail | mjones@yahoo.com | non- |
| Jones | | | | sequential |
| | | | | checks |

The foregoing example is intended only to demonstrate possible notification options. It is not intended to be exclusive or exhaustive. In varying embodiments, other parameters are saved and used. For example, in varying embodiments, conditional notification options are available to the subscribers. For example, the notifications can be programmed to transmit to different addresses for different times of day. For example, during business hours, John may have a notification to a first telephone number, such as his business telephone number and notifications may be directed to his home number in the evenings or during weekends. It is also programmable in various embodiments to save and perform combinations of notification options. For example, Mary Jones may request notifications to her e-mail and to a cellular telephone. She may also request that only certain events are sent to her based on importance. For example, checks that are ordered to a different address than the one she has on file may initiate an urgent notification to her cellular phone.

In varying embodiments, responses are requested from the subscriber as a form of verification. For example, Mary Jones may be requested to confirm a check order via e-mail once the notification is received. Such confirmations include, but are not limited to, voice responses to a voice response unit, email, DTMF or keypad response, wireless responses of the foregoing, and confirmations by other biometrics, including but not limited to voice recognition or fingerprint identification.

The notifications provided by the present system give a subscriber rapid information as to check printing orders to avoid fraudulent procurement of checks by thieves and accidental issuance of improperly prepared checks.

In one embodiment, the preferences are entered by an operator who stores preferences in the messaging means. In one embodiment, a secure web page with password protection is employed to provide direct subscriber access to review, modify, and/or store notification preferences. In one embodiment the subscriber's notification options are recorded on the form the subscriber fills out when applying for the system. Other storage methods may be employed without departing from the scope of the present system.

The different embodiments provided herein are combinable with a confirmation means. The confirmation means provides a confirmation by the recipient of the check order to inform the check printer or affiliated financial institution that the checks were received by the appropriate customer. For example, in one embodiment, the check order is shipped and a response from the customer is requested to confirm receipt of the order. Different authentication methods and systems are employed in varying embodiments. For example, in one embodiment a check order shipment contains an insert within the box of checks requesting that the subscriber call a special number to confirm receipt of the order. Such confirmations may be authenticated by having the subscriber provide some information indicating that they are indeed the intended customer of the check printer and/or financial institution. For example, in one embodiment, the authentication information is caller identification information transmitted by the subscriber's telephone service when calling in the confirmation. In one embodiment, the subscriber is asked to verify one or more items of information that are known primarily to the subscriber. For example, such information could be the last four (4) digits of the subscriber's Social Security Number or their mother's maiden name. Such verification could also be a predetermined password or question and answer series. Other types of authentication information and verifications may be employed without departing from the scope of the present subject matter.

For example, another confirmation method includes the use of a sticker on or in the box of checks requesting the subscriber to call to confirm receipt of the order. Yet another authentication method includes a separate communication sent to the subscriber requesting verification of receipt of the order by one or more methods, including, but not limited to, communications by telephone call, telephone voice response unit, telephone DTMF, mail delivery, facsimile, email, instant messaging, website login and any other wired or wireless communication.

In one embodiment, the confirmation includes an increased amount of authentication based on activity by the subscriber that is associated with a higher probability of fraud. For instance, if a subscriber recently changed mailing address, the system could be programmed to increase authentication vigilance to ensure that the proper subscriber is the recipient of the checks. In one embodiment, after an event, such as an address change, the recipient subscriber provides multiple sources of validating information. The caller identification information is tested along with the mother's maiden name. Other examples are possible without departing from the scope of the present subject matter. Other activities requiring increased vigilance include, but are not limited to, contact name changes and company name changes.

In embodiments where a separate communication is required of the recipient, if a first communication is sent to the recipient and not properly or promptly returned an additional follow up communication is sent to the subscriber. For example, a telephone call may be made to the subscriber.

The examples here show the flexibility of the present system and the notifications, events, and communication means shown are intended to demonstrate possible uses of the system. Those skilled in the art upon reading and understanding the present teachings will appreciate that other notifications and communications are possible without departing from the scope of the present system.

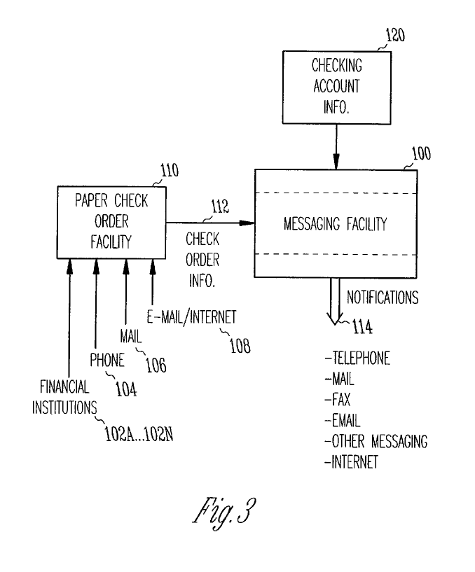

FIG. 3 demonstrates a system incorporating checking account information 120 according to one embodiment of the present system. In one embodiment, checking order information 120 includes a database of checking accounts which may be queried for the subscribers identified in subscriber database 220. Such information provides the subscriber an added service because notification options can be programmed to send notifications to a subscriber when for example a new checking account is opened in their name. This provides a significant deterrent to identity theft. Another aspect of the checking account information 120 is that certain financial institutions may participate to provide access to checking account information via encrypted electronic mail, secure server, virtual private network, or any other secure means. This affords a subscriber the ability to receive notification on a highly programmable basis for any number of checking account conditions. For example, a checking customer subscriber may decide to receive a notification in the event the balance of their checking account drops below a predetermined amount. For example, a subscriber may elect notification on a remaining balance amount, such as $1000. Another embodiment allows the subscriber to program a notification each time a check is processed. Another embodiment provides the subscriber a notice any time a check is presented which provides a NSF (non-sufficient funds) notice. Such a system affords the subscriber early detection of check fraud based on unauthorized check drafts reaching their checking financial institution. In varying embodiments, combinations of the foregoing notifications with highly flexible and programmable notification options are employed. For example, John Smith may elect to receive e-mail notifications when his checking account balance falls below $500 and notifications to his cell phone if an NSF code is received. Such notifications may be programmable for various days, dates, and times of day. The notifications are optionally based on parameters including but not limited to amounts, velocity, typical or atypical ordering method, check number, and/or check sequencing. Many notification options are provided to assist the subscriber in monitoring checking account transactions in one or more checking accounts.

In varying embodiments, the notifications are used in conjunction with acknowledgements. For example, an email notification may request a confirmation from the subscriber which is received by messaging facility 100 to confirm a transaction. For example, suppose a new account was opened in John Smith's name. John Smith is given the option of confirming that the new account was requested by him to avoid identity theft by another, in one embodiment of the present system. In varying embodiments, such notifications are used to authorize electronic funds transfers. Other combinations and variations of notifications and responses are possible without departing from the scope of the present system.

In varying embodiments, the checking account information 120 resides in an ensemble of disparate databases with independent access codes and communication modes. For example, the system allows the option of several financial institutions providing access to their various web sites, dedicated dial up telephone lines, and virtual private networks. The messaging facility 100 includes access information stored in storage 230 which is used by controller 210 to access the various networks and databases using receive means 200. In varying embodiments, it is understood that receive means 200 includes bidirectional communication means for secure access of and for querying one or more databases having checking account information 120. Subscriber database 220 includes information identifying subscribers for various financial institutions and accounts which may be used by controller 210 to form queries. The information is retrieved and notifications are processed using notification preferences database 240 and the resulting notifications are sent via the communication means 250 as discussed above.

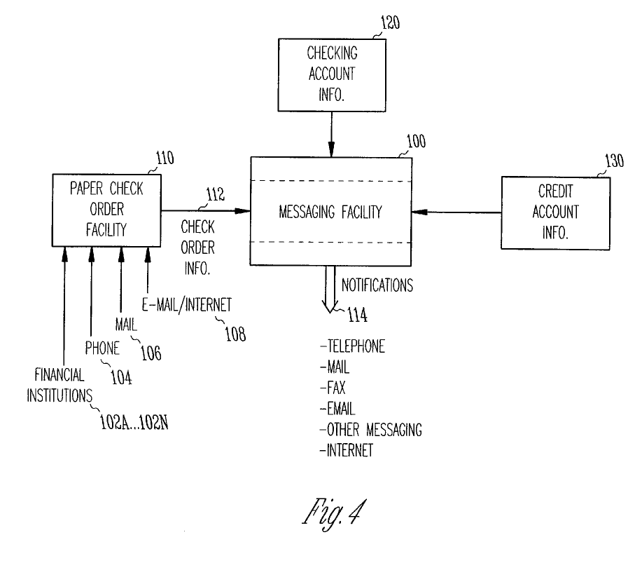

FIG. 4 shows one embodiment of the present system including access to credit account information 130. In one embodiment, secure access to a credit bureau is established. In one embodiment, the system receives credit information from a variety of sources or bureaus including but not limited to Equifax, Experian Information Solutions, Inc. and TransUnion. Other proprietary data sources may be used in varying combinations without departing from the scope of the present system.

Notifications are programmable for a number of parameters, including but not limited to, establishment of a new credit account, new charges to a credit account, changes to personal information such as mailing address, imposition of late payment fees, presentment of bills against a credit card number, reservation of amounts by vendors upon pending purchases, judgments or levies against the subscriber, and credit card account balances. A vast and rich number of parameters may be programmed to provide the subscriber with rapid notification of events and conditions in one or more credit card accounts. Such credit account information may also include other lending information including, but not limited to, mortgage payment and balance information, timeliness of such payments, and overall creditworthiness indicators. In the event a credit provider or check processor/printer provides a credit score or other metric for assessing the credit account or check order, the metrics are optionally used in producing notifications.

The system of FIG. 4 provides a plurality of notification functions to monitor and manage financial transactions which are likely to be the subject of fraud. The system provides programmable, flexible, and rapid notification of events and conditions in a plurality of accounts for a plurality of subscribers. The combinations provided herein are intended to demonstrate possible embodiments, however, it is understood that other notifications, financial data sources and modes of communication may be employed in varying combinations without departing from the scope of the present system. For example, additional sources of financial information include, but are not limited to, brokerage accounts, 401 k accounts, individual retirement accounts (IRAs), savings accounts and money market accounts. It is also understood that the system may differ in certain features without departing from the scope of the present teachings. For example, in one embodiment the check order information 112 from paper check order facility 110 and credit account information 130 is used, but the system does not include checking account information 120. Many combinations are possible without departing from the scope of the present teachings.

In one embodiment, the system provides enhanced management of financial accounts by providing an insurance option that subscribers can purchase to ensure that fraudulent uses of accounts in the subscriber's name will be addressed and the subscriber's record cleared. In one embodiment, the insurance option is provided to cover liabilities arising from fraudulent uses of the subscriber's credit. The insurance option is available to cover the costs of restoring the subscriber's good credit and may include specialists who have contacts with credit bureaus, lenders, and merchants to clear any fraudulent activity on the subscriber's accounts or ones fraudulently procured.

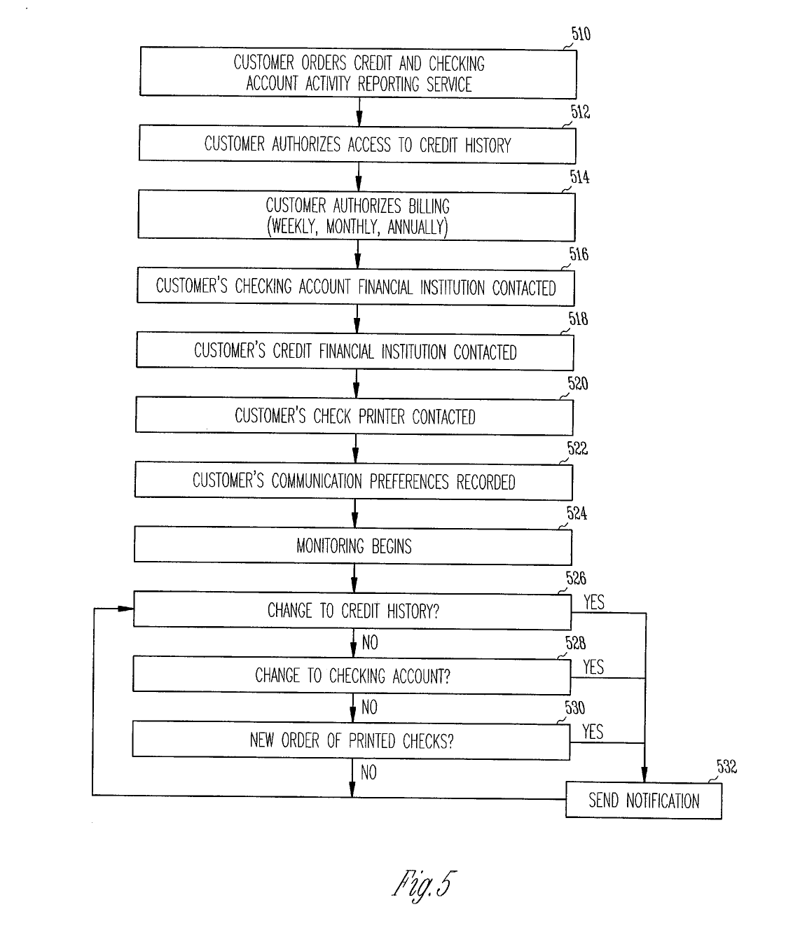

FIG. 5 is a flow diagram showing one example of how the notifications are provided according to one embodiment of the present system. At block 510 the customer/subscriber orders credit and checking account activity reporting. To do so, the customer/subscriber must authorize access to her financial accounts (block 512). In varying embodiments, a fee is charged to the subscriber for the service (block 514). The fee may be directly withdrawn from a savings or checking account or charged to a credit account. Such fees include, but are not limited to, periodic billings, transactional billings, one time charges, activation fees, and termination fees. In one embodiment, the charges are applied weekly, monthly, annually, or some other billing method, such as transactionally. Other billing methods and approaches may be used without departing from the scope of the present system. In varying offerings, the fees are optional and that the services described herein may be provided in combination with other offers and programs that do not involve a direct charge for the services.

Depending on the services selected by the subscriber, the customer/subscriber's financial institutions are contacted (516, 518) and the customer/subscriber's check printer is contacted (520). The subscriber's communication preferences are recorded (522). In some embodiments, a default communication is provided new subscribers to begin the service. These communication preferences may be recorded at several times during the subscription process and the order provided herein is intended to demonstrate one possible process. The preferences may be changed during the subscription.

Once monitoring begins (524) the subscriber's programmed accounts are monitored (526, 528) and check printing orders are monitored (530) and notifications are provided per the subscriber's programmed instructions (532). The monitoring process continues to proceed based on the preferences entered by the subscriber.

The flow chart of FIG. 5 is intended to demonstrate only one example of how the system may be used and is not intended in an exhaustive or limiting sense. It is noted that the system is highly programmable and a final implementation will depend on the exact programming of the subscriber's preferences.

In one approach to use of the present system a financial institution offers varying degrees of access and protection to prospective subscribers. For example, such approaches may offer tiered plans for access to various data sources and notification options. Additionally, such offers include the option of purchasing insurance for correction of the subscribers' credit accounts in the event of identity theft or other fraud. The insurance optionally includes coverage for costs incurred and liabilities incurred due to a fraudulent use of accounts. The service is enhanced with offerings of credit experts who will contact various credit services to rectify accounts on behalf of the subscriber. Such an approach offers varying services for different fees and/or subscriptions so that subscribers may select a service package that best suits their needs. Tiered service packages may include limited access to one or more databases. Several variations and programmable features are provided by the present system.

In one embodiment of the present system, information from the credit account providers is incorporated into the credit account information 130 to assist in identification of potentially fraudulent credit card transactions. In one embodiment, the credit account information includes one or more codes for identification of transactions that are deemed suspect by the credit bureau processing transactions.

In varying embodiments of the present system, the notifications and use of financial accounts may be tied into various points programs or other promotional activities of one or more financial institutions.

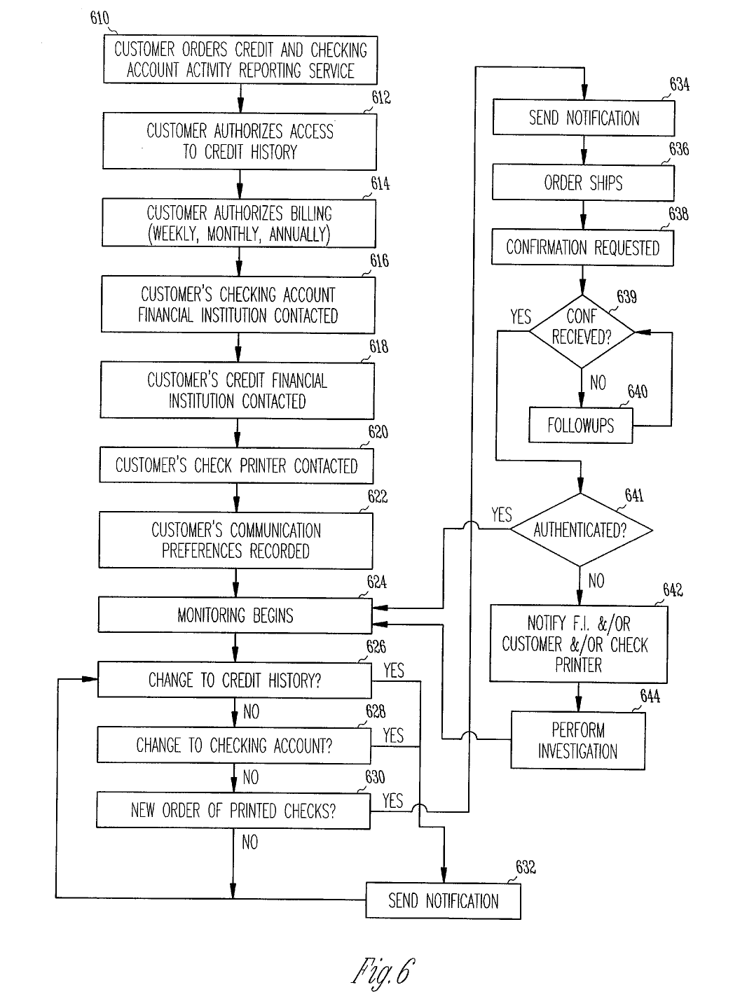

FIG. 6 is a flow diagram showing one example of how the confirmation of receipt of new check orders is provided according to one embodiment of the invention. Once checks are shipped, the subscriber is contacted to confirm receipt of the order (638). When a response is received from the subscriber, the identity of the subscriber is verified (641). If a response is not promptly returned from the subscriber, an additional communication is sent to the subscriber (640). In one embodiment, if the subscriber's identity cannot be verified or if no response is returned by the subscriber, an investigation is initiated (644). Optionally, if no response is returned from the subscriber, a notification is sent to either the subscriber, the check printer, or to a financial institution (642). It is also programmable in various embodiments to perform combinations of notification options (634).

The flow chart in FIG. 6 is intended to demonstrate only one example of how the system may be used and is not intended in an exhaustive or limiting sense. It is noted that the system is highly programmable and a final implementation will depend on the exact programming of the subscriber's preferences.

It is to be understood that the above description is intended to be illustrative, and not restrictive. Other embodiments will be apparent to those of skill in the art upon reviewing and understanding the above description. The scope of the invention should, therefore, be determined with reference to the appended claims, along with the full scope of equivalents to which such claims are entitled.

1-45. (canceled)

46. A system for communicating to a paper check order facility, a checking account information database, and a credit bureau and reporting financial activity to a subscriber, the system comprising:
a messaging facility configured to receive paper check order information from the paper check order facility, receive checking account information from the checking account information database, receive credit account information from the credit bureau, and provide notifications to the subscriber based on the paper check order information, the checking account information, the credit account information, and notification preferences for the subscriber, the notifications giving the subscriber rapid information as to check printing orders to avoid fraudulent procurement of checks and accidental issuance of improperly prepared check, the messaging facility including a notification preference database configured to store the notification preferences for the subscriber including instructions from the subscriber.

47. The system of claim 46, wherein the messaging facility is configured to receive the checking account information from an ensemble of disparate databases using access information and comprises a controller configured to receive the checking account information database and a storage configured to store the access information.

48. The system of claim 46, wherein the messaging facility is configured to allow the subscriber to access the notification preferences through a secure web page with password protection.

49. The system of claim 46, wherein the messaging facility is configured to provide the notifications using a plurality of programmable notification options programmably selected by the subscriber.

50. The system of claim 49, wherein the messaging facility is configured to provide the notifications using notification options programmed to be used for different types of communications.

51. The system of claim 50, wherein the messaging facility is configured to provide the notifications using notification options programmed to be used for differing urgencies of communications.

52. The system of claim 50, wherein the messaging facility is configured to provide notifications requesting responses from the subscriber as a form of verification.

53. The system of claim 50, wherein the paper check order facility comprises a check printer.

54. A method for communicating with subscribers regarding financial transactions, the method comprising:
receiving paper check order information;
receiving checking account information;
receiving credit account information from a credit bureau;
receiving notification preferences for the subscribers;
providing notifications to the subscribers based on the paper check order information, the checking account information, the credit account information, and the notification preferences, the notifications giving the subscriber rapid information as to check printing orders to avoid fraudulent procurement of checks and accidental issuance of improperly prepared checks.

55. The method of claim 54, wherein receiving the credit account information comprises receiving information on new charges to a credit account.

56. The method of claim 54, wherein receiving the credit account information comprises receiving information on change to personal information.

57. The method of claim 54, wherein receiving the credit account information comprises receiving information on imposition of late payment fees.

58. The method of claim 54, wherein receiving the credit account information comprises receiving information on presentment of bills against a credit card number.

59. The method of claim 54, wherein receiving the credit account information comprises receiving information on reservation of amounts by vendors upon pending purchases.

60. The method of claim 54, wherein receiving the credit account information comprises receiving information on judgments or levies against the subscriber.

61. The method of claim 54, wherein receiving the credit account information comprises receiving information on credit card account balances.

62. The method of claim 54, wherein receiving the notification options comprises receiving notification options for transmitting the notifications to different addresses and telephone numbers for different times of day.

63. The method of claim 62, wherein receiving checking account information comprises receiving information that a new checking account is open.

64. The method of claim 63, wherein receiving checking account information comprises receiving information that balance of a checking account drops below a predetermined amount.
